(19) United States
(12) Patent Application Publication
(10) Pub. No.: US 2008/0010008 A1
(43) Pub. Date: Jan. 10, 2008

(54) System and method of delivering vector based images to mobile devices

(76) Inventor: Miles Yi Cheng Yang, Ottawa (CA)

Correspondence Address: PEARNE & GORDON LLP, 1801 EAST 9TH STREET, SUITE 1200, CLEVELAND, OH, 44114-3108, US

(21) Appl. No.: 11/787,155

(22) Filed: Apr. 13, 2007

(30) Foreign Application Priority Data
Apr. 13, 2006 (CA) 2,543,527

(51) Int. Cl. G01C 21/00

(52) U.S. Cl. 701/208

(57) ABSTRACT

A method of preparing map data in a vector form for delivery to a wireless device is provided. The method being operative on a server and comprising the steps of receiving a request for a map, determining X,Y co-ordinates of a location center, determining an area of interest that contains the location center, generating a vector map for the area of interest, compressing the map data, and providing the map data to a user.

### FIELD OF INVENTION

The present invention relates to a system and method for the delivery of image information to mobile devices.

### BACKGROUND OF THE INVENTION

Traditional map servers for “wired” PC's use raster based images where the data is stored as an array of pixels. While providing quite accurate image information this system is quite costly in terms of the amount of data that is transmitted from the server to the user. In particular a large communication bandwidth is required to provide the data to the user in a reasonable time. Further, continuous communication between the user and the map server is required for user actions.

Today's mobile mapping applications implement traditional map servers to provide map images, which would be in a raster image format and are handled on a and per request based in real time. Thus there is considerable back and forth between the wireless device and the server to update the image for the user. While the above system architecture can be handled appropriately in wired systems, it is demanding on wireless systems due to the bandwidth, processing and memory limitations of wireless systems.

This current raster based image system has a number of limitations when its use to mobile device environment, such as but not limited to:

1. The map images are always in raster image format, which is large for wireless data transmission

2. The map images resolution is limited. The map images generated by traditional map server uses fixed resolution settings and ignores the display resolution capability of the mobile devices.

3. It significantly reduces the ability to overlay location relevant content on top of the map.

4. It is inflexible to fuse any real time location content on top of the map.

5. It significantly reduces the ability to interact with the map for additional information, such as a building.

6. It lacks the ability to allow user to zoom in/out and pan in each direction to see different views of the map locally.

7. It lacks the ability to allow user to search and highlight roads or other mapping objects for attention.

8. It consumes more time and data because most of the user interaction requires a new server response.

9. It demands user always to be in an area with good wireless coverage.

A new process to create maps that addresses the above issues is required. Further the new process should have the ability to combine and overlay any arbitrary location oriented content in real time, allow a user to have full interactivity with the map and its relevant contents, present the maps in the highest possible resolution the mobile device can support and significantly reduce the data and time on wireless traffic.

### SUMMARY OF THE INVENTION

The present invention relates to a system and method for delivering images and related content to a wireless device. In particular it relates to a system and method for the delivery of mapping information and location oriented content to mobile devices in real time. The real time content can be arbitrary content with a meaning relative to the location, such as traffic, local business, weather and location targeted advertising message. The location map is in a vector form allowing presentation to a user in many different views depending on the user interaction. Further the map can contain arbitrary mapping layers such as roads, highway, sewage system, parks, rivers etc.

It is an object of the invention to provide an improved and efficient delivery of dynamic images to mobile devices. It is a further object to mitigate or obviate at least one of the deficiencies of prior art systems for the delivery of maps to mobile devices.

According to an aspect of the present invention there is provided a method of preparing map data in a vector form for delivery to a wireless device, the method being operative on a server. A first step involves receiving a request for a map. A second step involves determining X,Y co-ordinates of a location center. A third step involves determining an area of interest that contains the location center. A fourth step involves generating a vector map for the area of interest.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a schematic diagram of a system according to an embodiment of the present invention;

FIG. 2 is a flow chart of the preparation of mapping information on the server according to a further embodiment of the present invention;

FIG. 3 is a flow chart of a process occurring on a server according to an embodiment of the present invention; and

FIG. 4 is a flow chart of a process occurring on a server according to an embodiment of the present invention.

### DETAILED DESCRIPTION

The current embodiment of the invention is applicable to the delivery of maps and associated content to mobile devices. This information is delivered to the mobile device upon receipt of a request for a map from the user of the device. In particular the system and method of the current embodiment provides the user with mapping and content information for a particular area of interest. After the receipt of this information the user can access information within the area of interest without providing a further request to the server. With the receipt of information for the area of interest the user can access both map and content information within this area without further accesses to the server. A new access to the server is only required when information that is outside of the current area of interest is requested.

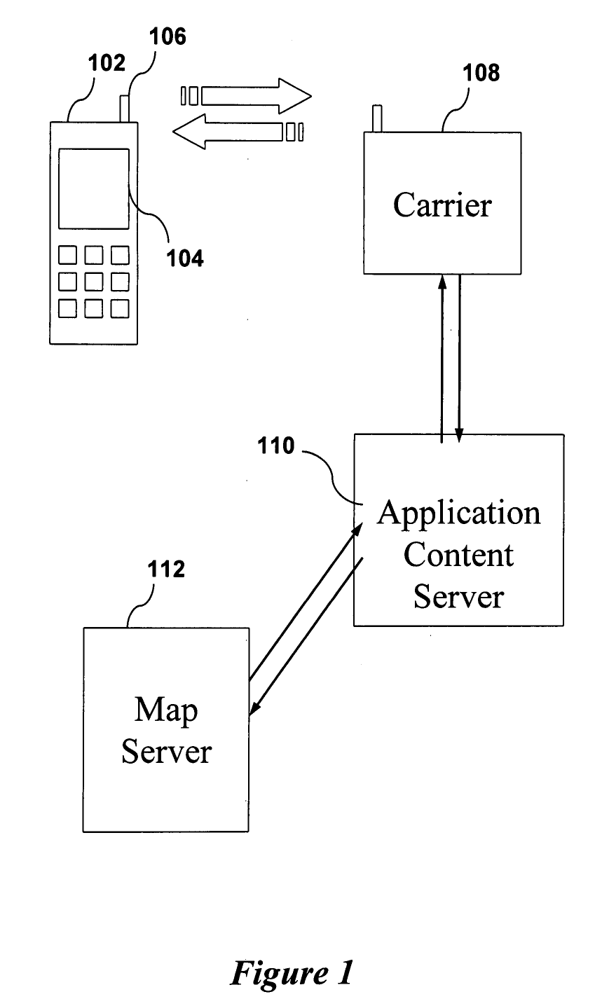

FIG. 1 is a schematic diagram of a communications system that includes the system of the current embodiment. Wireless device 102 may be a cell phone, so called smart phone, PDA or wireless email device. In general wireless device 102 may be any mobile device that can communicate wirelessly. The device 102 will have a display 104. The display 104 will generally be a display that is appropriate for displaying images. Further the display will generally have a minimum size of QCIF. The device 102 will also have an antenna 106 that is used for wireless communications. It will be apparent to those of skill in the art that antenna 106 is for representational purposes only and may in fact have a different configuration or may located internal to device 102.

The device 102 will communicate with a carrier 108. The carrier 108 is a simplification of the infrastructure including, servers, towers etc. that is associated with a provider of wireless communications.

The server 110 is a server of the current embodiment. Namely the server 110 will perform calculations and assemble data for communication to the device 102 through the carrier 108. The server 110 receives spatial data from the spatial server 112. The spatial server 112 is any spatial server with access to spatial database. It will be apparent to those of skill in the art that other comparable sources of spatial data are within the scope of the current invention.

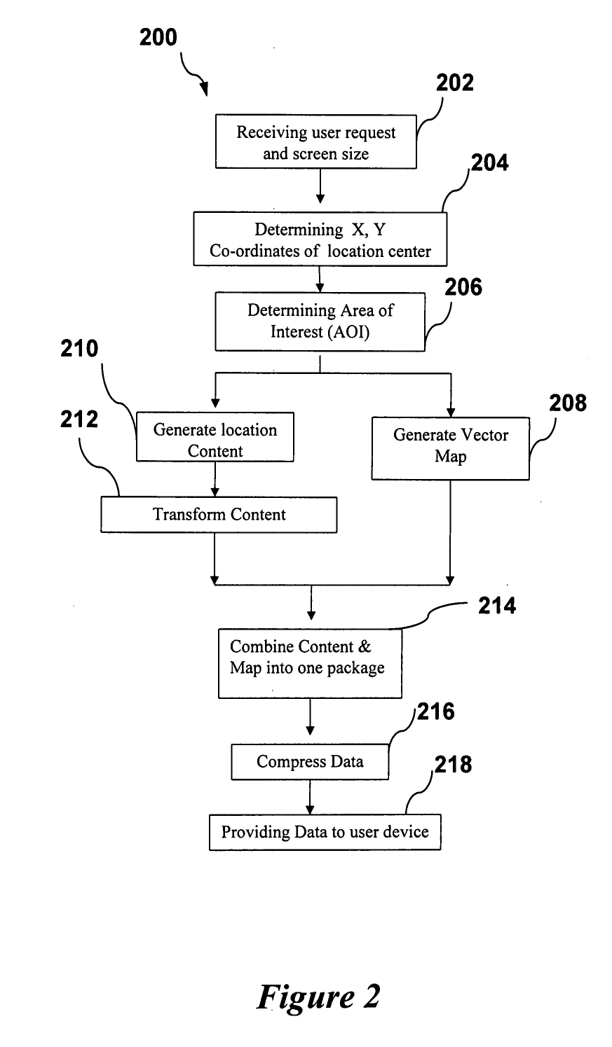

FIG. 2 presents a flow chart of the processes that occur on the server 110 according to an embodiment of the invention. A request is made by the wireless device 102 and is received by the server 110 at step 202. The screen size of the device 102 is also received at step 202. At step 204 the X,Y co-ordinates of the map are determined at step 204. These X,Y co-ordinates will generally represent a specific location in which a user of the device 102 is interested.

At step 206 the Area of Interest is determined. The area of interest (AOI) will generally be an area surrounding the location center where the area is determined the size of the display 104. For example, if the display 104 is a QCIF display the AOI according to the current embodiment will be 2 km by 2 km with the location center being at the center of this area. The AOI is arbitrary, but directly related to the location.

After the AOI is calculated at step 206 the process 200 splits into two paths where the map is calculated along one path and the content that is relevant to the AOI is determined along another path. A vector map for the AOI will be created at step 208. It should be noted that there will be a process operating on the device 102 that can render a vector map for display on the display 104.

The use of vectors is an important aspect of the current embodiment. Namely by representing geometry objects such as streets as vectors one can greatly reduce the amount of information that must be transmitted to the device 102. It also allows the delivery of content. Thus a street may be have co-ordinates (X₁,Y₁) at one edge of the AOI and (X₂,Y₂) at the other edge. Its trajectory across the AOI can then be represented by one or more vectors. Thus if the street is straight only a single vector is required.

The precision available from a vector based representation of the map data is acceptable for the targeted application. The map precision can be defined by the Application Server 110. Namely the map that is presented on display 104 is for defined purposes, such as orientation, and does not have to represent all details of the spatial data that is available on the spatial server 112.

When creating the vector map the server 110 determines what approximations can be made regarding the precision of the objects such as streets. Namely a street having a curvature less than a predefined amount may be determined to be represented by a single vector or reduce the number of points in the vector. Another curvature may be represented by a two vectors and so on.

When obtaining the relevant location content from the content database, the content is based on the same AOI as the vector map. A location content such as a local business will be transformed into a position or predefined position on the vector map from the above.

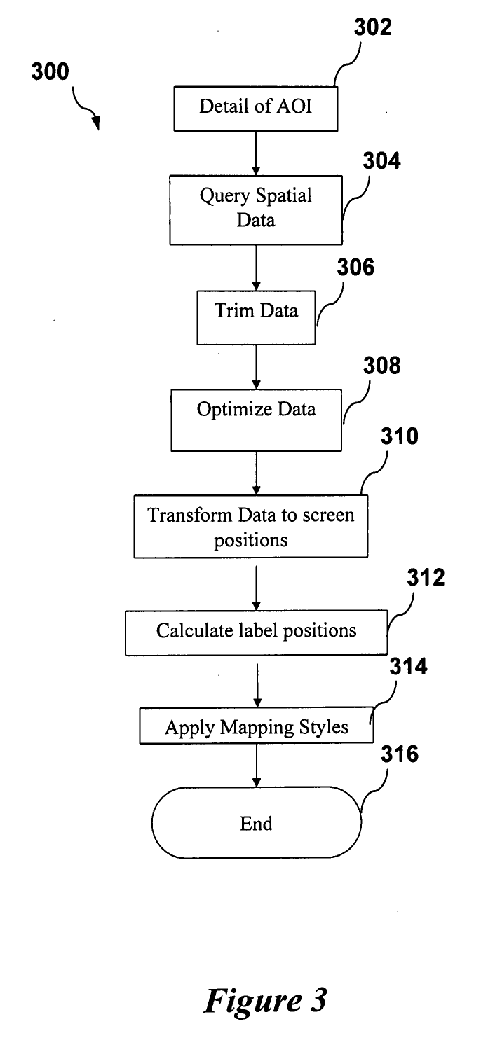

FIG. 3 presents a flow chart of a method 300 of preparing data for delivery to the mobile device. The process outlined in FIG. 3 is

The generation of a vector map at step 208 and the process as outlined in FIG. 3 can be executed in either real time in response to a user request or ahead of time as a batch process. A real time process may be desirable for situations where there are a limited number of requests for a given map. In these cases the map can be calculated in real time for every request. However, for some maps, particularly those that are frequently requested, it may be advantageous to generate them before a specific request. In this case the maps may be considered pre-built. Generally these pre-built maps will be larger than is provided for a given request. For example, a pre-built map may represent an area of 10 km by 10 km while the AOI provided for a particular request will generally be 2 km by 2 km.

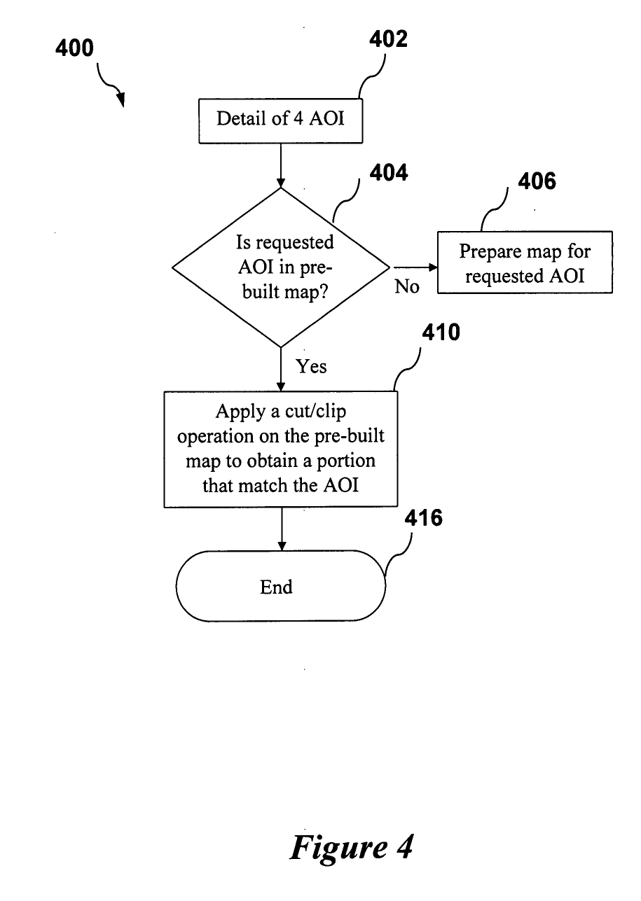

FIG. 4 presents a flow chart of a process 400 for extracting a requested map from a pre-built map. At step 402 the AOI for a particular request is received. At step 404 the pre-built maps are checked to determine whether they contain the requested AOI. If the requested AOI is contained in a pre-built map the AOI is “extracted” from the pre-built map at step 410. If the requested map is not contained in a pre-built map a map is prepared at step 406. The process then ends at step 416.

The present invention has been described with regard to one or more embodiments. However, it will be apparent to persons skilled in the art that a number of variations and modifications can be made without departing from the scope of the invention as defined in the claims.

What is claimed is:

1. A method of preparing map data in a vector form for delivery to a wireless device, the method being operative on a server, the method comprising the steps of:
receiving a request for a map;
determining X,Y co-ordinates of a location center;
determining an area of interest that contains the location center; and
generating a vector map for the area of interest.

2. The method according to claim 1 further comprising the steps of:
generating location content that is applicable to the area of interest;
transforming the content; and
combining the content with the vector map data.

3. The method of claim 1 wherein the map is generated in real time in response to a user request.

4. The method of claim 2 wherein the map is generated in real time in response to a user request.

5. The method of claim 1 wherein the map is generated prior to a specific user request.

6. The method of claim 2 wherein the map is generated prior to a specific user request.

7. The method according to claim 3 further comprising the steps of:
compressing the map data; and
providing the map data to a user.

8. The method according to claim 4 further comprising the steps of:
compressing the map data; and
providing the map data to a user.

9. The method according to 5 further comprising the steps of:
compressing the map data; and
providing the map data to a user.

10. The method according to claim 6 further comprising the steps of:
compressing the map data; and
providing the map data to a user.
